(19) United States
(12) Patent Application Publication
(10) Pub. No.: US 2005/0081894 A1
(43) Pub. Date: Apr. 21, 2005

(54) Safety actuation device for a dish-washing machine

(76) Inventor: Gianluca Pardini, Lucca (IT)

Correspondence Address: THOMPSON HINE LLP, 2000 COURTHOUSE PLAZA N.E., 10 WEST SECOND STREET, DAYTON, OH, 45402-1758, US

(21) Appl. No.: 10/963,912

(22) Filed: Oct. 13, 2004

(30) Foreign Application Priority Data
Oct. 17, 2003 (IT) BO2003A000608

(51) Int. Cl. B08B 13/00

(52) U.S. Cl. 134/56 R; 134/58 R; 134/115 R; 134/201

(57) ABSTRACT

A safety actuation device for a dish-washing machine comprises a fixing element for fixing the device to a supporting structure of the dish-washing machine, an electric motor, a pin designed to rotate in a circular way, a transmission assembly for transmitting the motion from the motor to the pin, a bar, which moves fixedly with respect to the electric motor, an elastic-resistance assembly, which acts on the bar, and a switch, which can be operated by the safety element and is designed to interrupt electrical supply to the electric motor.

The present invention relates to a safety actuation device for a dish-washing machine.

### BACKGROUND OF THE INVENTION

Generally, dish-washing machines used in establishments such as hotels and restaurants comprise means for moving the dish rack, constituted by a mobile carriage which moves according to a reciprocating translational motion, which comprises, in turn, thrust teeth, which are hinged to a frame and have a shape such as to exert thrust on the rack only when the carriage is displaced in one of the two directions. The reciprocating motion of the carriage is due to the engagement of a pin, subjected to a circular movement, with a handle element of the carriage, in such a way as to transform the circular motion of the pin into a reciprocating translational motion of the carriage. The pin usually belongs to an actuation device comprising an electric motor and a set of gears that transfer the motion from the motor to the pin itself. In a device of this sort it may occur that when the dish rack, for any reason, get jammed, also the carriage and the pin get jammed in their movement, causing damage to the actuation device as a whole. In particular, it is possible for the motor, by overheating, to burn out and for the gears that transmit motion from the motor to the pin to get damaged or even break.

There has thus been felt the need to provide an actuation device for the movement means in a dish-washing machine, the technical characteristics of which will be able to prevent damage when the movement means themselves get jammed.

### SUMMARY OF THE INVENTION

The subject of the present invention is a safety actuation device for a dish-washing machine, comprising a fixing element designed to be fixed to a supporting structure of the dish-washing machine, an electric motor, a pin designed to rotate in a circular way, and a transmission assembly for transmitting motion from the motor to the pin; said device being characterized in that it comprises a bar element, which is fixed to a first one of its ends and has a second one of its ends free and is able to move fixedly with said electric motor, and a switch, which can be operated by said bar element and is designed to interrupt electrical supply to said electric motor.

### BRIEF DESCRIPTION OF THE DRAWINGS

The example of embodiment presented in what follows has a purely illustrative and non-limiting purpose, in order to enable a better understanding of the invention, with the aid of the annexed plate of drawings, in which:

FIG. 1 is a perspective view of a dish-washer, with parts removed, which comprises a preferred embodiment of the actuation device according to the present invention;

FIG. 2 is a view from above of the actuation device of FIG. 1 in one of its operating positions; and

FIG. 3 is a view from above of the actuation device of FIG. 1 in one of its further operating positions.

### DETAILED DESCRIPTION OF THE INVENTION

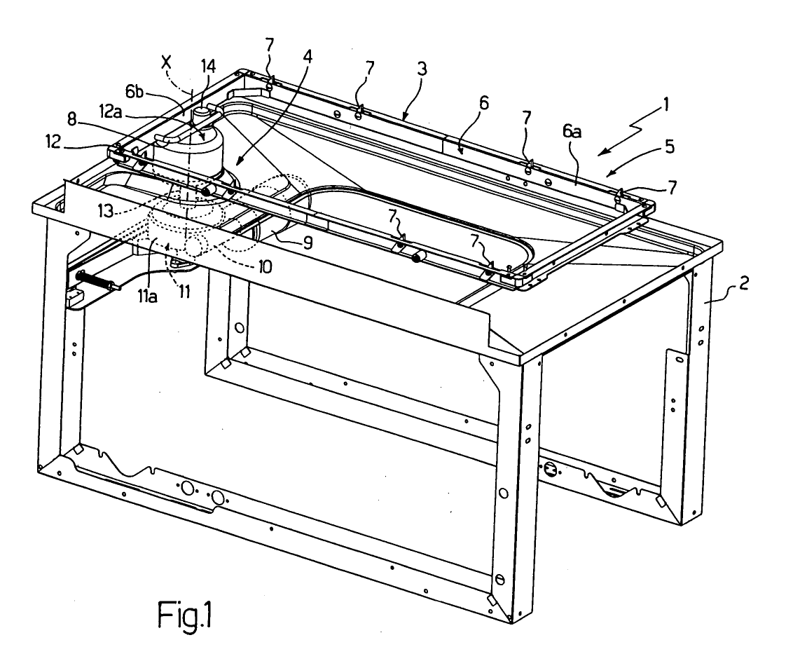

In FIG. 1, designated as a whole by 1 is a dish-washing machine. The dish-washing machine 1 comprises a supporting structure 2, movement means 3, and an actuation device 4 for the movement means 3. The movement means 3 comprise a thrust carriage 5, comprising, in turn, a rectangular frame 6, a plurality of engagement teeth 7 hinged on two long sides 6a of the frame 6, and a handle element 8 fixed to a short side 6b of the frame 6.

The actuation device 4 comprises an electric motor 9, a motor shaft 10, a motor-reducer assembly 11 enclosed in a casing 11a, and a cylindrical body 12, which rotates about an axis X of its own thanks to the gear of a transmission shaft 13 of its own with the motor-reducer assembly 11, and a pin 14 mounted in an eccentric way on a top surface 12a of the cylindrical body 12 in such a way as to be able to move in a circular way.

The actuation device 4 is fixed to the supporting structure 2 in a known way by means of a bracket (not illustrated) extending from the casing 11a.

The pin 14 engages the handle element 8 in such a way as to transform its own circular motion into a reciprocating translational motion of the thrust carriage 5.

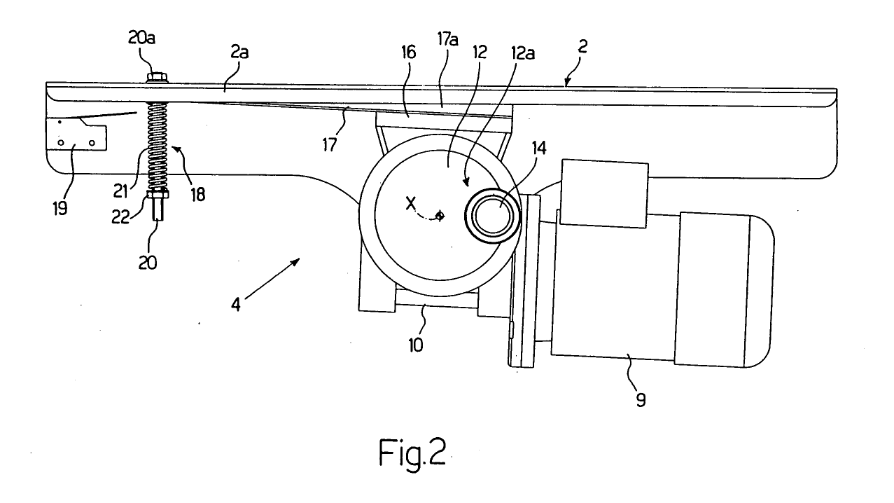

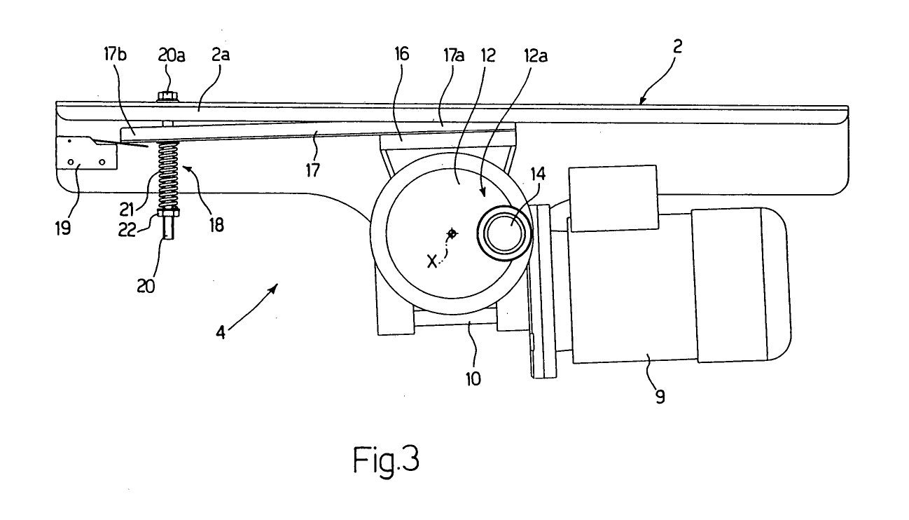

As illustrated in a more detailed way in FIGS. 2 and 3, the actuation device 4 comprises: a bracket 16, which also extends from the casing 11a of the motor reducer 11; a bar 17, a first end portion of which 17a is fixed to the bracket 16 and a second end portion of which 17b is free; an elastic-resistance assembly 18, which acts on the bar 17 in the proximity of the second end portion 17b; and a switch 19, which is set in such a way as to be operated by the end portion 17b itself and is designed, once operated, to interrupt the current supplying the electric motor 9.

The elastic-resistance assembly 18 is constituted by a screw 20, which traverses both a portion 2a of the supporting structure 2 and the bar 17, and the head 20a of which is set bearing upon the portion 2a, and a spring 21 wound around the screw 20 and compressed between the bar 17 and a nut 22 screwed on the screw 20. The elastic-resistance assembly 18 has the characteristic of being able to be calibrated by varying the position of the nut 22 on the screw 20, which results in a variation of the compression of the spring 21 and hence in a variation of the resistance that the spring 21 itself exerts on the bar 17.

In use, after calibration of the elastic-resistance assembly 18, the actuation device 4 is actuated, which during its normal operation causes the second end portion 17b of the bar 17, under the thrust of the spring 21, to be brought up to the portion 2a of the supporting structure 2 (FIG. 2). Starting from this position of operation of the bar 17, if the pin 14 is prevented from continuing in its circular motion, which happens, for example, in the event of the dish rack getting jammed, the resistance opposed by the transmission shaft 13 to the gears of the motor reducer 11 causes, as will appear obvious to a person skilled in the art, the motor reducer 11 itself and the electric motor 9 to start to rotate, by reaction, about the axis X. When the assembly constituted by the motor reducer 11 and the electric motor 9 turns, it draws along in rotation also the bar 17, which, once the action of the spring 21 is overcome, is detached from the portion 2a of the supporting structure 2 until it encounters the switch 19 (FIG. 3). Once the end portion 17b of the bar 17 encounters the switch 19, it operates the latter, and consequently the electrical supply to the motor 9 is interrupted.

As will appear obvious from the foregoing description, the actuation device according to the present invention enables, in a simple and efficient way, interruption of the supply of current to the motor, as soon as there occurs an obstruction of the movement means, thus preventing any damage to the actuation device.

Furthermore, the device according to the present invention affords the advantage of enabling calibration of the elastic means of resistance so as to prevent the bar 17 from operating the switch 19 on account of a mere vibration of the actuation device itself.

1. A safety actuation device (4) for a dish-washing machine (1), comprising a fixing element (15) designed to be fixed to a supporting structure (2) of the dish-washing machine (1), an electric motor (9), a pin (14) designed to rotate in a circular way, and a transmission assembly (11) for transmitting motion from the motor (9) to the pin (14), said device being characterized in that it comprises a bar element (17), which fixed to one first of its end portions (17a) and has one second of its end portions (17b) free and is designed to move fixedly with said electric motor (9), and a switch (19), which can be actuated by said bar element (17) and is designed to interrupt electrical supply to said electric motor (9).

2. The actuation device according to claim 1, characterized in that said free second end portion (17b) of the bar element (17) co-operates with said switch (19).

3. The actuation device according to claim 1, characterized in that it comprises elastic means (18), which are designed to oppose resistance to a movement of the bar element (17).

4. The device according to claim 3, characterized in that said elastic means (18) co-operate with said second end portion (17b) of the bar element (17).

5. The device according to claim 4, characterized in that said elastic means comprise a screw (20), which traverses both a portion (2a) of the supporting structure (2) and the bar element (17) and the head (20a) of which is set bearing upon said portion (2a), and a spring (21) wound around the screw (20) and compressed between the bar element (17) and a nut (22) screwed on the screw (20).

6. The device according to claim 5, characterized in that said transmission assembly (11) is housed in a casing (11a), on which said first end portion (17a) of said bar element (17) is fixed.

7. A dish-washing machine, characterized in that it comprises a safety actuation device according to claim 1.
